(19) United States
(12) Patent Application Publication
(10) Pub. No.: US 2024/0219079 A1
(43) Pub. Date: Jul. 4, 2024

(54) VEHICLE AIR-CONDITIONING DEVICE USING SEMICONDUCTOR AS COOLING CORE

(71) Applicant: Chuan-Sheng Chen, Taipei City (TW)

(72) Inventor: Chuan-Sheng Chen, Taipei City (TW)

(21) Appl. No.: 18/092,919

(22) Filed: Jan. 3, 2023

(51) Int. Cl. F25B 21/02; B60H 1/00; B60H 1/32

(52) U.S. Cl. CPC F25B 21/02; B60H 1/0065; B60H 1/00878; B60H 1/32; B60H 2001/3286; F25B 2321/0251

(57) ABSTRACT

A vehicle air-conditioning device using semiconductor as a cooling core includes a thermoelectric cooling chip, a cold circulator, heat-dissipating equipment, and a set of electricity supplying and temperature controlling circuit. The thermoelectric cooling chip is electrically connected to a power supply and temperature controller to receive electricity and one end forms a cold generation surface abutting the cold circulator and an opposite end forms a heat generation surface abutting the heat-dissipating equipment. The cold circulator includes a winding-tube return flow box having a surface including temperature-reducing conducting fins, a cold-generation ice water tank, a temperature-receiving conducting plate, fans, and auxiliary temperature-transmitting equipment including electrical water pump. The cold-generation ice water tank to which the winding-tube return flow box is connected is stacked thereon with the temperature-receiving conducting plate. The fans are arranged around the temperature-reducing conducting fins to drive air through the temperature-reducing conducting fins to become cooled air.

### TECHNICAL FIELD OF THE INVENTION

The present invention relates generally to a vehicle air-conditioning device using semiconductor as a cooling core, and more particularly to a structure of a vehicle air-conditioning device using semiconductor as a cooling core, which is novel and better improves an effect of cooling and is easy to lay out and optimizes adaptation to variation of driving status.

### DESCRIPTION OF THE PRIOR ART

The present inventor has previously developed vehicle air-conditioning equipment using semiconductor as a cooling core, which does not involve compressor and coolant that have been traditionally used, and consumes only electricity, so as to reduce the loading of the vehicle and is more suit for electrical vehicles, and can be installed in various vehicles of all sizes to facility the development of vehicles in the trend of weight reduction and better environmental friendliness.

Such vehicle air-conditioning equipment that uses semiconductor as a cooling core, which may be used as a vehicle air-conditioner as shown in the schematic view of FIG. 1, mainly comprises at least one thermoelectric cooling chip 10, 11, a cold circulator 20, heat-dissipating equipment 30, and a power supply and temperature controller 50, wherein the thermoelectric cooling chips 10, 11, when electrical connection ends thereof being electrically connected to the power supply and temperature controller 50 to conduct in electrical power, forms a cold generation surface at one end thereof and also forms a heat generation surface at an opposite end thereof, and the cold generation surface is placed tightly against the cold circulator 20, and the heat generation surface is placed tightly against the heat-dissipating equipment 30. The cold circulator 20 is made up of a winding-tube return flow box 23 of which a surface is mounted with temperature-reducing conducting fins 21, 22 distributed thereon, the cold-generation ice water tank 24, a temperature-receiving conducting plate 25, fans 26, 27, and auxiliary temperature-transmitting equipment 40 that includes an electrical water pump 41 to increase a water flowing speed. The cold-generation ice water tank 24 to which a water egress tube of the winding-tube return flow box 23 is connected receives the temperature-receiving conducting plate 25 to stack thereon to support, in a manner of being in tight abutting engagement therewith, the cold generation surfaces of the thermoelectric cooling chips 10, 11. The fans 26, 27 are arranged around the temperature-reducing conducting fins 21, 22, and the fans 26, 27 drive air in a vehicle cabin to circulate and flow through the winding-tube return flow box 23 in which the temperature-reducing conducting fins 21, 22 are mounted. The electrical water pump 41 is installed on a proper piping section of the winding-tube return flow box 23 for circulating and pumping back to the cold-generation ice water tank 24. The heat-dissipating equipment 30 is made of a heat-dissipating fan module 31 of a vehicle head part front driving compartment and a heat-dissipating fan module frontward air filter net 32. The heat-dissipating fan module 31 is set upright and placed proximity to the heat generation surfaces of the thermoelectric cooling chips 10, 11. At that time, the heat-dissipating fan module 31 is only a single unit of electronic fan. The power supply and temperature controller 50 of which a power-supplying output terminal is electrically connected to the thermoelectric cooling chips 10, 11 and a power input terminal is electrically connected to a vehicle power source is mainly a surface panel on which a main control interface device 54 having a power switch 51, a temperature rising/lowering control button 52, and the constant-temperature control button 53 is mounted for setting a desired constant temperature or increase or decrease of temperature, so as to set the heat-dissipating equipment and the cold circulator as an air cooling/heating device that regulates preset cooling/heating air-conditioning and temperature-regulating for inside and outside vehicle cabin. The fans 26, 27 drives the air in the cabin interior space 60 to circulate for temperature reducing. Each button surface of the power switch 51, the temperature rising/lowering control button 52, and the constant-temperature control button 53 protruding from the power supply and temperature controller 50 can certainly be combined with or directly serve as temperature regulation operation interface of the cabin interior space 60 protruding outside air-conditioning temperature regulation dashboard zone.

In a tank inner side of the cold-generation ice water tank 24 on which the temperature-receiving conducting plate 25 is stacked, a temperature-reducing conducting bar 29 having a bar body from which multiple conduction plates 28A, 28B that are closely arranged project is suspended downwardly to extend into in-tank water contained in the cold-generation ice water tank 24, and the temperature-reducing conducting bar 29 functions to enlarge temperature-reducing conducting surface area for a low temperature generated by the cold generation surfaces of the thermoelectric cooling chips 10, 11 and transmitted through the temperature-receiving conducting plate 25 into the interior of the cold-generation ice water tank 24 to reduce, in a more quickly manner, a temperature of water that moves, as a tube flow, from the winding-tube return flow box 23 back to the interior of the cold-generation ice water tank 24. Although such a structure seems a perfect one, yet there is still deficiency when installed and used in a vehicle. An analysis is provided below.

Referring to FIG. 2, which is a schematic view, in a sectioned form, showing a sideways inclined in-tank structure liquid surface status in a single, non-partitioned, cold-generation ice water tank during driving, as shown in sectional view of the sideways inclined in-tank structure liquid surface status during driving, the cold-generation ice water tank 24 included in the known device invented by the present inventor is such a single non-partitioned tank. The surface of water stored in the cold-generation ice water tank 24 is naturally affected by the motion status of the vehicle being driven in an inclined road, inertial of fast acceleration, inertial of sudden deceleration, or centrifugal forces generated by turning, so as to change the stability of a relative position of the water surface with respect to an inside wall of the cold-generation ice water tank 24. During traveling stably through a flat surface, the water surface inside the tank can easily maintain parallel to a plane set by a housing of the cold-generation ice water tank 24, but during such motion status as an inclined road, inertial of fast acceleration, inertial of sudden deceleration, or centrifugal forces generated by turning, water stored in the cold-generation ice water tank 24 is caused to oscillate, making the water surface of the water stored in the cold-generation ice water tank 24 not parallel with the plane set by the housing of the cold-generation ice water tank 24, thus generating fluid oscillation to impact the housing of the cold-generation ice water tank 24, resulting in quakes, which, once accumulated with time, would make the housing itself and the mechanical structure around the housing loosened due to such impacts or becoming oblique and deformed. Thus, such fluid oscillation should be reduced as much as possible in order to long maintain mechanics reliable.

Further referring to FIG. 3, which is a schematic view, in a sectioned form, showing a sideways inclined in-tank structure liquid surface status in a single, partitioned, cold-generation ice water tank during driving, when the structure shown in FIG. 3, as being invented previously by the present inventor, is implemented, the adverse factor of impacts resulting from oscillation of fluid inside the cold-generation ice water tank 24 can be alleviated. For example, during traveling in a road surface that is inclined at an angle of A, the housing of the cold-generation ice water tank 24 is affected by the posture of the vehicle to incline at the angle A, but water itself has the property of maintaining a horizontal water surface. Thus, the water surface of the water stored in the cold-generation ice water tank 24 shown in FIG. 1 naturally inclines relative to a horizontal plane originally defined by the housing of the cold-generation ice water tank 24 by at least the angle A. Assuming a volumetric horizontal average dimensional width of the cold-generation ice water tank 24 is W1, an increase or decrease amount H of the stored water surface of the cold-generation ice water tank 24 along the tank wall as being inclined with respect to the housing of the cold-generation ice water tank 24 is +0.5W1*tan(A) or −0.5W1*tan(A), and it is noted here that this does not count an amount of impact resulting from potential energy converted intensively from kinetic energy due to inertia. Oppositely, for the cold-generation ice water tank 24 shown in FIG. 2 having the same size, the interior is provided with a partition plate 70, of which the bottom is not open for communication, to divide water stored therein into two sections of water surface, and a volumetric horizontal average dimensional width W2 of each partitioned chamber is only half of the previous value W1, and under the condition of traveling on a road surface inclining at an angle A, for each partitioned water chamber, an increase or decrease amount h of stored water surface of the cold-generation ice water tank 24 along the tank wall as being inclined with respect to the housing of the cold-generation ice water tank 24 is +(0.5)*W2*tan(A) or −0.5*W2*tan(A); and W2−0.5*W1. This clearly reduce the amount of fluid oscillation and thus achieves an effect of reducing the deterioration of mechanical stability caused by the oscillation.

However, the present inventor got aware that up to FIG. 3, the solution is still imperfect, because installation of such a set of air conditioning system in a vehicle still involves issues of installation space available, and for installation in a vehicle head part front driving compartment, there are already a lot of mechanical and electrical systems arranged therein and available free space is limited and is generally fragmented and separated, so that it is uncertain whether the size of the cold-generation ice water tank 24 that is currently available can be fit therein, while the cold-generation ice water tank 24 has to be of a sufficient size in order to sufficient capacity of water accumulation to hold a sufficient amount of low temperature or cold for long operation of air conditioning, not to mention this is further limited by the installation positions of a heat-dissipating fan module 31 and a heat-dissipating fan module front-side air filter net 32 (it being noted that the heat-dissipating fan module 31 and the heat-dissipating fan module front-side air filter net 332 are not shown in FIG. 3, reference being had to FIGS. 1 and 7), and thus, the cold-generation ice water tank 24 must be arranged in a relatively frontward part of a vehicle head part front driving compartment, and the winding-tube return flow box 23 be installed in a rear part of the vehicle head part front driving compartment that is relatively close to the driver dashboard, so that piping from the cold-generation ice water tank 24 to the winding-tube return flow box 23 is a relatively long piping router, making it easy for the cold water conveyed along the piping to dissipate cold and get rise of temperature during the course of conveyance, resulting in a defect that the flow that reaches the winding-tube return flow box 23 is not good for dissipating and supplying a desired cold temperature.

### SUMMARY OF THE INVENTION

Thus, the present invention provides a vehicle air-conditioning device using semiconductor as a cooling core, which as shown in FIG. 4, modifies the cold-generation ice water tank 24 into a front water tank 24A and a rear water tank assembly 24B, wherein the rear water tank assembly 24B can be a single tank or plural tanks connected in cascade with tubes, so that the operation of the entire system is based on at least two split tanks in which a water egress end connection tube of the front water tank 24A is connected to the rear water tank assembly 24B, and each tank's volumetric horizontal average dimensional width W3 of the front water tank 24A and the rear water tank assembly 24B is not greater than the size W1 shown in FIG. 2, and a sum of water storage capacities of the front water tank 24A and the rear water tank 24B is not less than that of the single unit of the cold-generation ice water tank 24 in the previous inventions, and thus, this only involves splitting into two tanks of which each tank is of a half of the occupation space of the original tank, so that there is no need to arrange the partition plate 70 shown in FIG. 3, wherein each tank's volumetric horizontal average dimensional width W3 is equal to the previous width W2, and under the same traveling condition, the amount of oscillation of in-tank fluid generated in FIG. 3 is clearly much lower, achieving an advantage of reducing quake and optimizing adaption to variation of traveling situations. As to a reversed flow caused by a height difference among lifting of each tank body of the front water tank 24A and the rear water tank 24B in an inclined road, an electrical water pump 41A having a pump speed greater than a pre-estimated flow speed of a reversed flow caused by the largest inclination angle of traveling and the inertial kinetic energy can be set on piping between the front water tank 24A and the rear water tank 24B to prevent such a revered flow. This is an objective of the present invention.

Further, preferably, in the vehicle air-conditioning device using semiconductor as a cooling core according to the present invention, each tank's volumetric horizontal average dimensional width W3 of the front water tank 24A and the rear water tank assembly 24B is less than the size W1 of the previously described single tank, so that individual tank bodies of the front water tank 24A and the rear water tank assembly 24B that are relatively small can be separately fit into crowded and segmented spaces in the interior of a vehicle head part front driving compartment of a vehicle, and the water egress end of the front water tank 24A is connected separately to connection tubes of the rear water tank assembly 24B, so that sectionized tube connection can be applied to ease connection therebetween by detouring around other components inside the vehicle head part front driving compartment, making the installation thereof in a vehicle easy. This is another objective of the present invention.

Further, the vehicle air-conditioning device using semiconductor as a cooling core according to the present invention is such that the original way of tube connection made to a middle section of tubing of the winding-tube return flow box 23 is modified to include the rear water tank assembly 24B to have a surface area to temperature storage volume ratio of each tank much lower than a surface area to temperature storage volume ratio of the original way of the water egress end of the single cold-generation ice water tank 24 being directly extended to the tubing middle section of the winding-tube return flow box 23, and the surface area to temperature storage volume ratio being lower indicates better performance of temperature keeping property, temperature dissipating being relatively slow, so that the defect that cold of the cold water being dissipated and temperature thereof being raised during a conveyance course where no temperature dissipating is desired to make the circulating flow that reaches into the winding-tube return flow box 23 being incapable of generating desired cold temperature, and thus the effect of cooling of air conditioning can be better exploited. This is a further objective of the present invention.

### BRIEF DESCRIPTION OF THE DRAWINGS

FIG. 1 is a schematic view showing embodiment of a known vehicle air-conditioning device using semiconductor as a cooling core.

FIG. 2 is a schematic view, in a sectioned form, showing a sideways inclined in-tank structure liquid surface status in a single, non-partitioned, cold-generation ice water tank of FIG. 1 during driving.

FIG. 3 is a schematic view, in a sectioned form, showing a sideways inclined in-tank structure liquid surface status in an improved known single, partitioned, cold-generation ice water tank during driving.

FIG. 4 is a cross-sectional view, in a sectioned form, showing a sideways inclined in-tank structure liquid surface status in a split cold-generation ice water tank of a vehicle air-conditioning using semiconductor as a cooling core according to the present invention during driving.

FIG. 5 is a schematic view showing embodiment of the vehicle air-conditioning device using semiconductor as a cooling core according to the present invention.

FIG. 6 is a schematic view showing an arrangement circuit of the vehicle air-conditioning device using semiconductor as a cooling core according to the present invention.

FIG. 7 is a schematic view showing the vehicle air-conditioning device using semiconductor as a cooling core according to the present invention installed in a front-side driving compartment of a head part of a vehicle.

FIG. 8 is an enlarged view of a portion of FIG. 7.

FIG. 9 is a schematic view showing a front water tank of the vehicle air-conditioning device using semiconductor as a cooling core according to another embodiment of the present invention.

FIG. 10 is a schematic view showing a rear water tank of the vehicle air-conditioning device using semiconductor as a cooling core according to another embodiment of the present invention.

FIG. 11 is a schematic view showing a circuit of the vehicle air-conditioning device using semiconductor as a cooling core according to another embodiment of the present invention.

### DETAILED DESCRIPTION OF THE PREFERRED EMBODIMENT

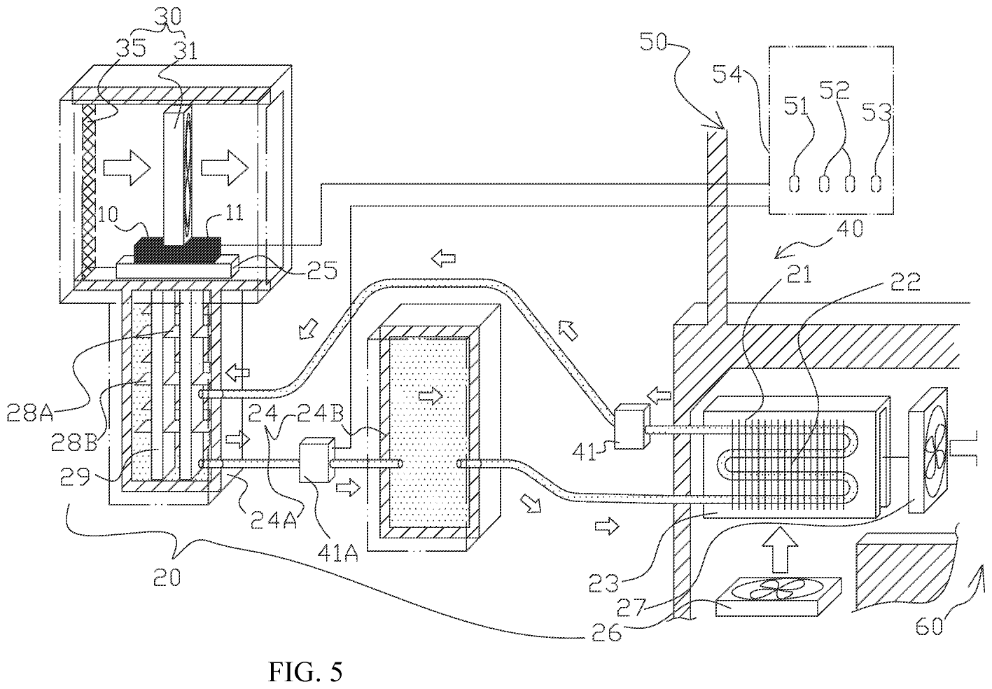

As shown in FIG. 5, the present invention provides a vehicle air-conditioning device using semiconductor as a cooling core, which similarly comprises at least one thermoelectric cooling chips 10, 11, a cold circulator 20, heat-dissipating equipment 30, and a set of electricity supplying and temperature controlling circuit 50, wherein the thermoelectric cooling chips 10, 11, when electrical connection ends thereof being electrically connected to the set of electricity supplying and temperature controlling circuit 50 to conduct in electrical power output from corresponding connection contacts of an air conditioning controller 55 equipped in a vehicle, form a cold generation surface at one end thereof and also form a heat generation surface at an end thereof opposite to the cold generation surface. The cold generation surface is in tight abutment engagement with the cold circulator 20, and the heat generation surface is in tight abutment engagement with the heat-dissipating equipment 30. The cold circulator 20 comprises a winding-tube return flow box 23 of which a surface is provided with temperature-reducing conducting fins 21, 22 distributed thereon, a cold-generation ice water tank 24, a temperature-receiving conducting plate 25, fans 26, 27, and auxiliary temperature-transmitting equipment 40 including an electrical water pump 41 for speeding up a water flow. The cold-generation ice water tank 24 connected by detouring tubing with a water egress tube of the winding-tube return flow box 23 is stacked thereon with the temperature-receiving conducting plate 25 that is in tight abutting engagement with the cold generation surfaces of the thermoelectric cooling chips 10, 11. The fans 26, 27 are arranged around the temperature-reducing conducting fins 21, 22, and the fans 26, 27 drive air in a vehicle cabin to circulate and flow through the winding-tube return flow box 23 in which the temperature-reducing conducting fins 21, 22 are mounted. The electrical water pump 41 is installed on a proper tubing section position. The heat-dissipating equipment 30 comprises at least one heat-dissipating fan module 31 and a vehicle head part front driving compartment front side air filter net 35. The heat-dissipating fan module 31 must be arranged posterior to the vehicle head part front driving compartment side air filter net 35. The heat-dissipating fan module 31 is set upright and placed in proximity to the heat generation surface of the thermoelectric cooling chips 10, 11. Here, the heat-dissipating fan module 31 can be a single unit of electronic fan. The set of electricity supplying and temperature controlling circuit 50 is connected to the corresponding connection points of the vehicle-equipped air conditioning controller 55, and a power supply input terminal of the set of electricity supplying and temperature controlling circuit 50 opposite to wire connection thereof to the air conditioning controller 55 is electrically connected to the thermoelectric cooling chips 10, 11. The power input terminal of the air conditioning controller 55 is electrically connected to a vehicle power source. Operating the air conditioning controller 55 may control and regulate in-vehicle temperature. The air conditioning controller 55 is a main control interface 54 having a surface panel on which a power switch 51, a temperature rising/lowering control button 52, and the constant-temperature control button 53 are provided, by which setting a desired constant temperature or increase or decrease of temperature are made. Basically, for the main control interface 54, the power switch 51, the temperature rising/lowering control button 52, and the constant-temperature control button 53 can be of a hardware structure having a physical form of button or key, yet with the progress of digitization and the trend of control through virtual image control for the operation dashboards of modern vehicles, it is also feasible that the power switch 51, the temperature rising/lowering control button 52, and the constant-temperature control button 53 of the main control interface 54 can be digital graphic touch control virtual button structure in wire connection and operating in combination with the set of electricity supplying and temperature controlling circuit 50. Operating the main control interface 54 may set the heat-dissipating equipment and the cold circulator as an air cooling/heating device that regulates preset cooling/heating air-conditioning and temperature-regulating for inside and outside vehicle cabin. The fans 26, 27 drives the air in the cabin interior space 60 to circulate for temperature reducing. Each button surface of the power switch 51, the temperature rising/lowering control button 52, and the constant-temperature control button 53 of the air conditioning controller 55 protruding therefrom can certainly be combined with or directly serve as temperature regulation operation interface of the cabin interior space 60 protruding outside air-conditioning temperature regulation dashboard zone. The fans 26, 27 arranged around the temperature-reducing conducting fins 21, 22 of the winding-tube return flow box 23 can also be roller fans.

Similarly, in a tank inner side of the cold-generation ice water tank 24 on which the temperature-receiving conducting plate 25 is stacked, temperature-reducing conducting bars 29 having bar bodies from which multiple conduction plates 28A, 28B that are closely arranged project is suspended downward, wherein, as shown in the drawing, the conduction plates 28A, 28B and the temperature-reducing conducting bars 29 are in the form of rectangular slats extends into in-tank water contained in the cold-generation ice water tank 24, and the temperature-reducing conducting bar 29 functions to enlarge a temperature-reducing conducting surface area so that a low temperature generated by the cold generation surface of the thermoelectric cooling chips 10, 11 is transmitted through the temperature-receiving conducting plate 25 into the interior of the cold-generation ice water tank 24 to reduce, in a more quickly manner, a temperature of water that moves, as a tube flow, from the winding-tube return flow box 23 back to the interior of the cold-generation ice water tank 24.

The present invention modifies the cold-generation ice water tank 24 into a front water tank 24A and a rear water tank assembly 24B. The rear water tank assembly 24B can be a single rear water tank or plural rear water tanks connected in cascade with tubes. The number of tanks included in the rear water tank assembly 24B can be increased or decreased as desired according to for example the sizes and number of split installation spaces in the interior of the vehicle head part front driving compartment, and accordingly, at least two separate tank bodies are involved in the operation of the entire system. A water egress end connection tube of the front water tank 24A is connected to the rear water tank assembly 24B, and the front water tank 24A is set in contact engagement with the temperature-receiving conducting plate 25, and a circulation tube is extended from a last one of the rear water tanks of the rear water tank assembly 24B to connect to the winding-tube return flow box 23, and the winding-tube return flow box 23 is tube-connected to an opposite end of the last rear water tank to directly tube-connect back to the front water tank 24A. Each tank's volumetric horizontal average dimensional size of the front water tank 24A and the rear water tank assembly 24B is smaller than the volumetric horizontal average dimensional size of the prior art cold-generation ice water tank 24, and a total water storage capacity of a sum of the front water tank 24A and the rear water tank assembly 24B is not less than a total water storage capacity of the prior art single cold-generation ice water tank 24, and the temperature-reducing conducting bars 29 are suspended down and projecting from the inner side of the front water tank 24A on which the temperature-receiving conducting plate 25 is stacked. Such a split or separated structural arrangement achieves the effect of reducing the total fluid oscillation amount the cold-generation ice water tank 24 as mentioned previously to reduce quake caused by the oscillation and optimizing adaption to variation of traveling. In addition to the electrical water pump 41 mounted on the suitable tubing section position for circulating from the winding-tube return flow box 23 back to the cold-generation ice water tank 24, there may be an extra electrical water pump 41A mounted on a proper piping section to speed up the flow.

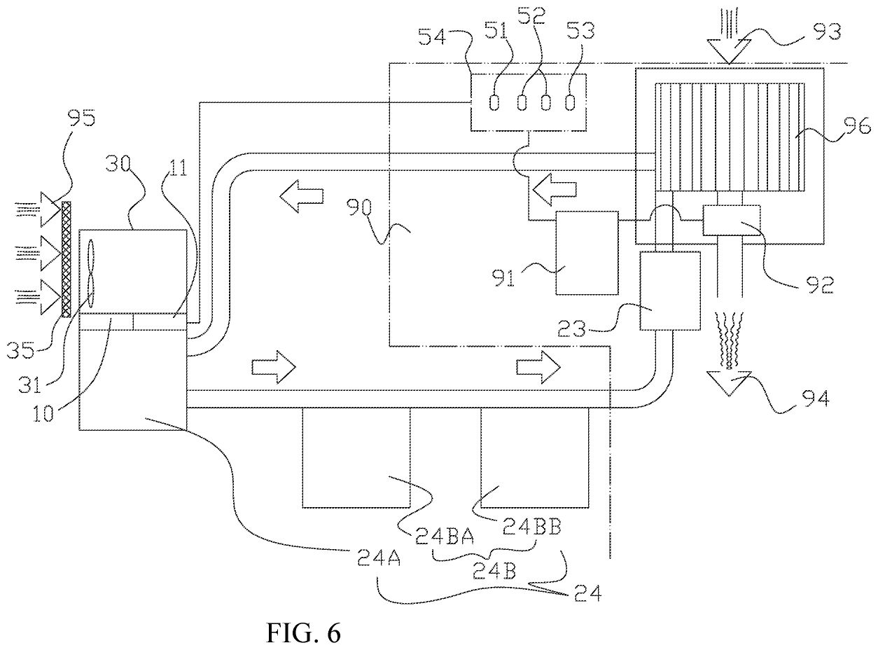

Construction can be made in the way as that shown in the schematic view of circuit shown in FIG. 6. This drawing splits the rear water tank assembly 24B further into a first rear water tank 24BA and a second rear water tank 24BB, and this drawing includes the schematic layout as shown in FIG. 5 and also includes, arranged in a vehicle dashboard side air-conditioning air outlet duct space 90, an entire-vehicle main control computer 91 to which a temperature sensor 92 is connected for wire-connection to the previously mentioned power supply and temperature controller 50 to establish complete operation and control over a cooling temperature inside the vehicle to allow for smooth flowing for cold-absorbing intake air 93, air-conditioning blowing air 94, and outside-vehicle intake air 95. Further, the fans 26, 27 described in FIG. 5 can be combined a single air-blowing fan 96.

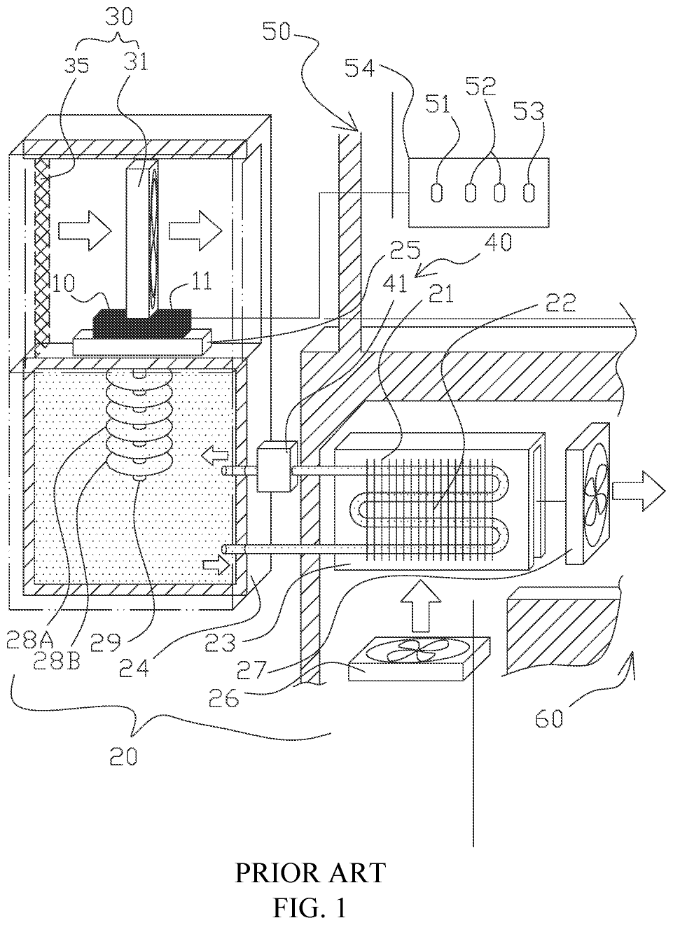

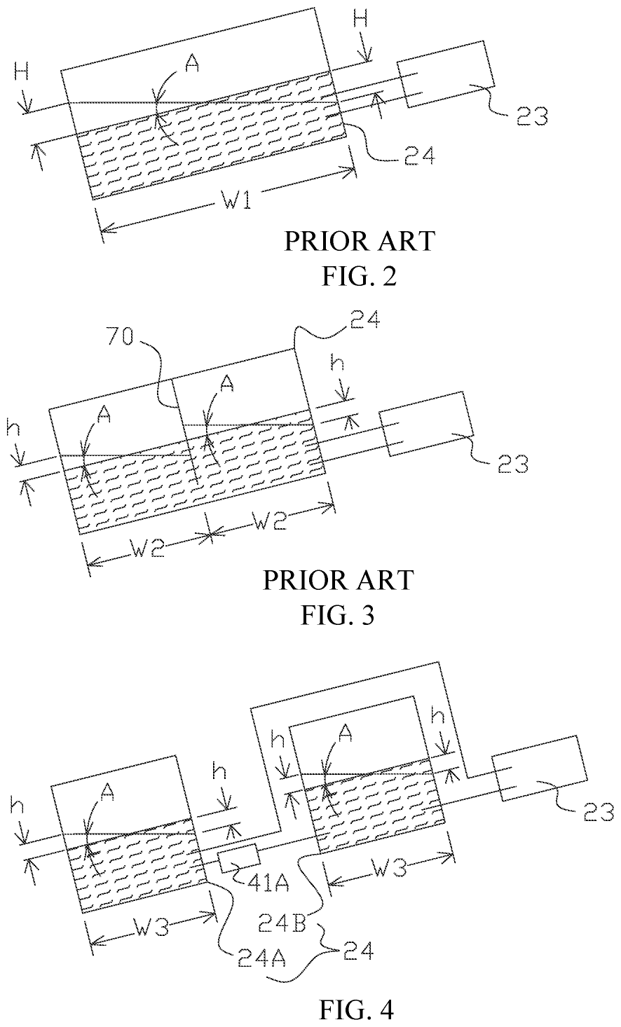

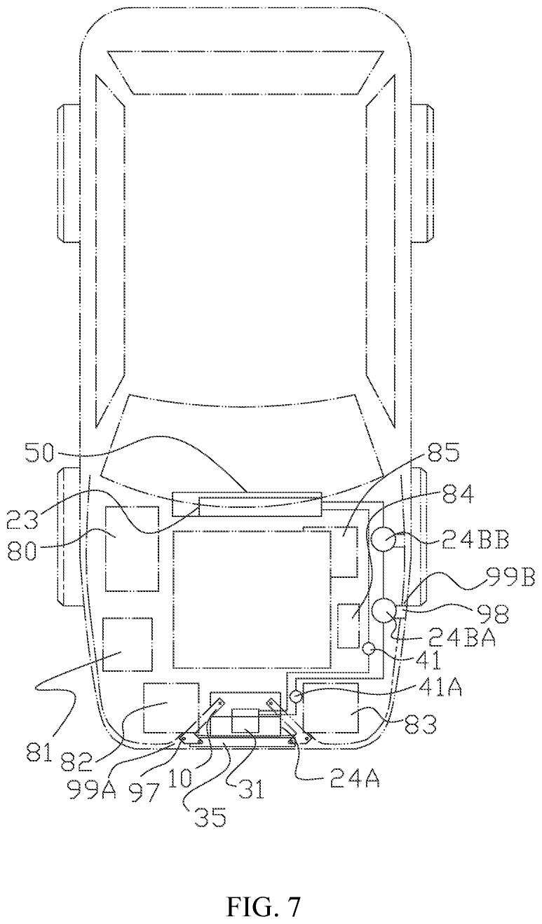

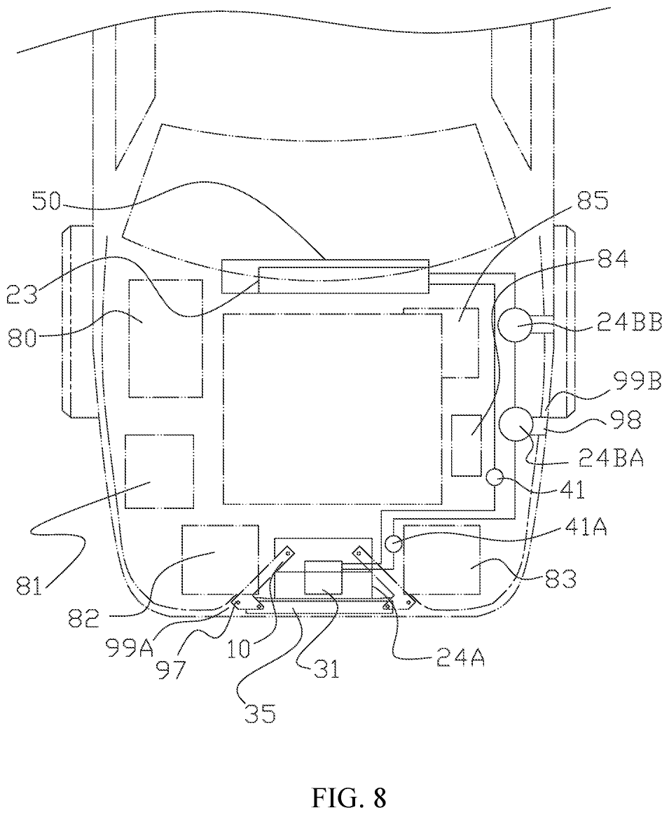

As to the installation of the whole device in a vehicle, as shown in the schematic view of FIG. 7 and the partial enlarged view of FIG. 8, the two drawings aim to represent the schematic view of a vehicle in a more concrete way, in order to exhibit potential layout location of each element or component of the present invention device in a vehicle structure. By having each tank's volumetric horizontal average dimensional width of the front water tank 24A and the rear water tank assembly 24B smaller than the size of the single tank of the previous inventions, the front water tank 24A and the rear water tank 24B that occupy relatively small areas can be separately fit into crowded and segmented spaces in the vehicle head part front driving compartment, with connecting tube, being arranged in sectioned formed, detouring around other existing components 80, 81, 82, 83, 84, 85 inside the vehicle head part front driving compartment (it being noted that the term “vehicle head part front driving compartment” as used herein is traditionally referred to as an engine bay in an engine-driving vehicle; however, this invention is also applicable to a modern newly-invented full electrical, engine-less, electrical self-driving vehicle, so that the term “vehicle head part front driving compartment” is adapted), and being fixed through screwing with fasteners 97, 98 to housing walls 99A, 99B of the vehicle head part front driving compartment to then connect to piping layout and wire layout, so that the installation, as a whole, to the vehicle is made easy. Even more advantageously, the original way of tubing connection being made to a tubing middle section of the winding-tube return flow box 23 is modified by including the rear water tank assembly 24B itself having a surface area to temperature storage volume ratio that is much lower than a surface area to temperature storage volume ratio of the tubing middle section without including the rear water tank assembly 24B, and the surface area to temperature storage volume ratio being lower indicates better performance of temperature keeping property, temperature dissipating being relatively slow, so that the defect that cold of the cold water being dissipated and temperature thereof being raised during a conveyance course where no temperature dissipating is desired to make the circulating flow that reaches into the winding-tube return flow box 23 being incapable of generating desired cold temperature, and thus, the effect of cooling of air conditioning can be better exploited. It is noted that the illustration of FIG. 1 provides just one way of layout, yet inference can be made therefrom that the present invention is applicable to electrical vehicles and all sorts of large and small vehicles.

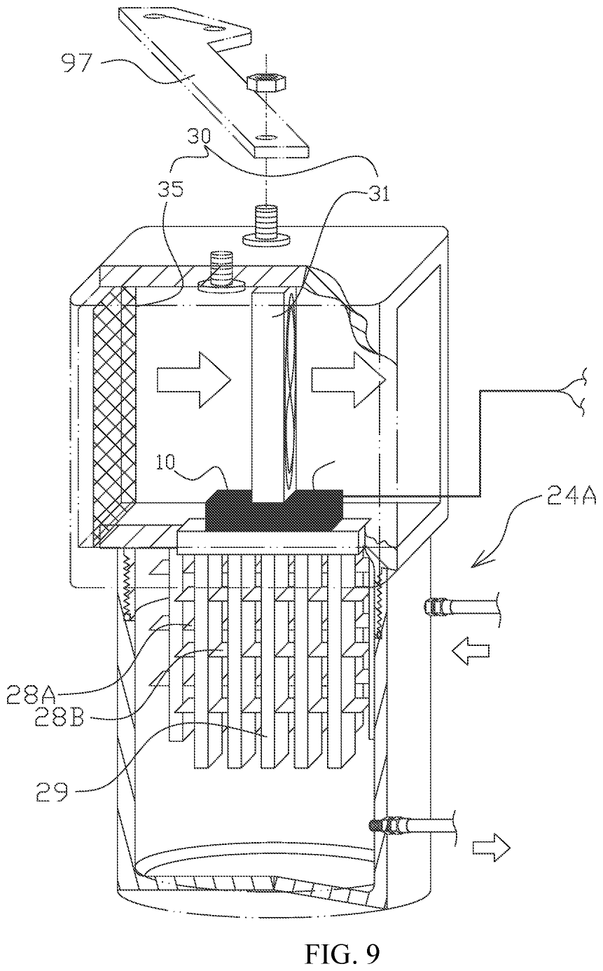

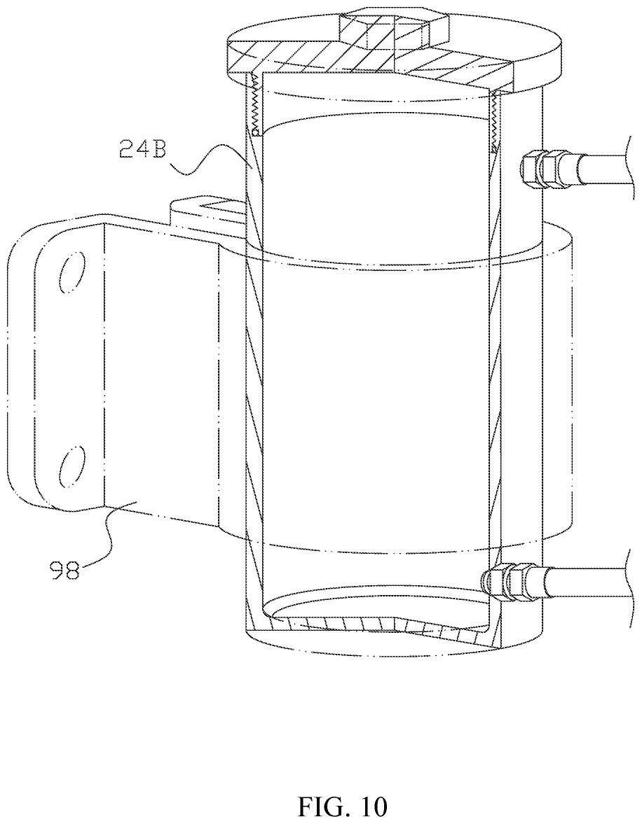

Further, as shown in FIG. 9, the previously described front water tank 24A can be modified such that at least a portion of the housing thereof to which the temperature-reducing conducting bars 29 are mounted is made as a cylindrical housing, so that water flow inside the housing become a vertex that is made smoother to reduce stagnation slow-flowing zones caused by ridges and edges inside the housing to thereby provide better effect of temperature homogenization. Similarly, as shown in FIG. 10, the housing of the previously described rear water tank assembly 24B (including the first rear water tank 24BA and the second rear water tank 24BB) can be made as a cylindrical housing for the purposes of reduce stagnation slow-flowing zones caused by ridges and edges inside the housing.

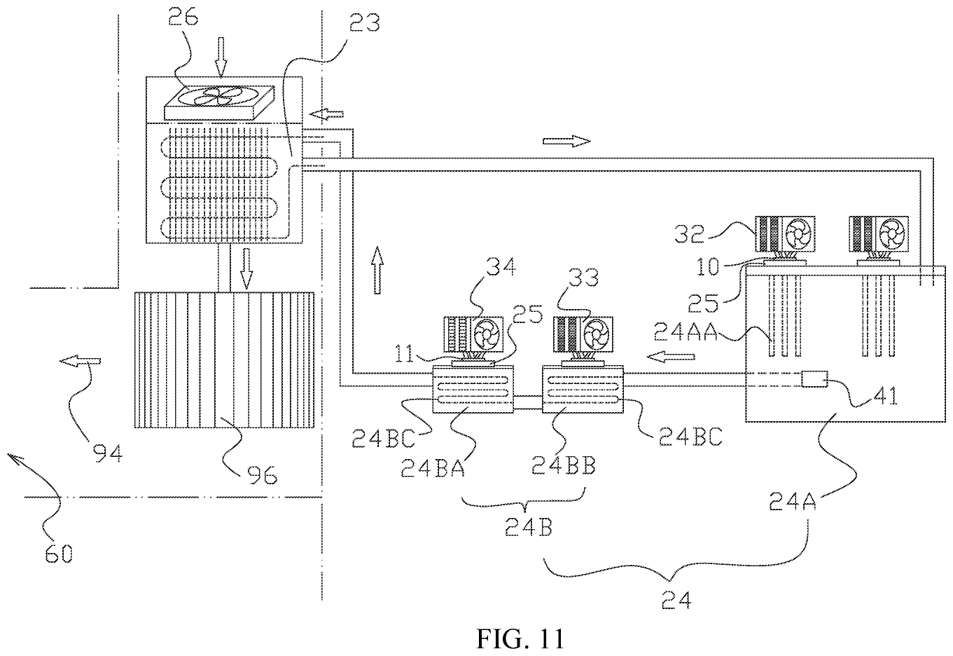

Further, as depicted in the schematic view of a circuit of another embodiment shown in FIG. 11, in the vehicle air-conditioning device using semiconductor as a cooling core according to the present invention, the heat-dissipating fan modules 32, 33, 34 can be a combined body of an electronic fan stacked with grating row blocks penetrated and connected by heat-conducting tubes, and the cold-generation ice water tank 24, either the front water tank 24A or the rear water tank assembly 24B, may have a top thereof stacked with the temperature-receiving conducting plate 25 in tight abutting engagement with the cold generation surface of the thermoelectric cooling chips 10, 11, and the heat generation surface of the electrical cooling chip 10, 11 is then stacked with the heat-dissipating fan module 32, 33, 34, wherein the front water tank 24A can be an aluminum alloy cold water tank of which an inner tank side stacked with the temperature-receiving conducting plate is modified to include an aluminum plate array 24AA suspending downward and projecting from the inner tank top surface to dip into in-tank water for expanding a surface for cold transmitting into water, and the first rear water tank 24BA and the second rear water tank 24BB of the rear water tank assembly 24B are both aluminum alloy water passage tanks penetrated through interior thereof to form cold water circuitous passageways 24BC, and it is noted that in the drawing, the cold water circuitous passageways 24BC are shown with phantom lines in a schematic way, yet actually, the entirety of the passageway of the cold water circuitous passageway 24BC is parallel attached under the cold generation surface of the thermoelectric cooling chip 11, so that the cold water circuitous passageway 24BC may fully flow slow to absorb the replenishing cold temperature transmitted from the thermoelectric cooling chip 11, and further, the electrical water pump 41 is mounted at a tubing section proper location, and in addition to the proper tubing section proper location for circulating and pumping from the winding-tube return flow box 23 back to the cold-generation ice water tank 24, modification can be made to mounting inside the cold-generation ice water tank 24 at a tube outlet toward the rear water tank assembly 24B.

I claim:

1. A vehicle air-conditioning device using semiconductor as a cooling core, mainly comprising at least one thermoelectric cooling chip, a cold circulator, heat-dissipating equipment, and a set of electricity supplying and temperature controlling circuit, wherein the thermoelectric cooling chip has an electrical connection end electrically connected to the power supply and temperature controller to receive electricity and forms a cold generation surface at an end thereof and also forms a heat generation surface at an end opposite to the cold generation surface, the cold generation surface being in tight contact engagement with the cold circulator, the heat generation surface being in tight contact engagement with the heat-dissipating equipment, the cold circulator comprising a winding-tube return flow box of which a surface is provided with temperature-reducing conducting fins, a cold-generation ice water tank, a temperature-receiving conducting plate, fans, and auxiliary temperature-transmitting equipment including an electrical water pump for speeding up water flowing, the cold-generation ice water tank connected by detouring tubing with a water egress tube of the winding-tube return flow box is stacked thereon with the temperature-receiving conducting plate that is in tight abutting engagement with the cold generation surface of the thermoelectric cooling chip, the fans being arranged around the temperature-reducing conducting fins, the fans driving vehicle cabin air to circulate and flow through the winding-tube return flow box in which the temperature-reducing conducting fins are mounted, the electrical water pump being mounted on a proper tubing section position, the heat-dissipating equipment comprising at least one heat-dissipating fan module and a vehicle head part front driving compartment air filter net, the heat-dissipating fan module being arranged posterior to the vehicle head part front driving compartment air filter net, the heat-dissipating fan module being set upright and arranged in proximity to the heat generation surface of the thermoelectric cooling chip, the set of electricity supplying and temperature controlling circuit being externally connected to a corresponding connection point of a vehicle-equipped air conditioning controller, a power supply input terminal of the set of electricity supplying and temperature controlling circuit opposite to wire connection thereof to the air conditioning controller being electrically connected to the thermoelectric cooling chip, the power input terminal of the air conditioning controller being electrically connected to a vehicle power source, mainly a main control surface having a surface panel on which a power switch, a temperature rising/lowering control button, and a constant-temperature control button are provided, operating the air conditioning controller regulating and controlling an in-vehicle temperature, characterized in that different from a cold-generation ice water tank in a prior art structure that is of a form of a singular body, the cold-generation ice water tank is divided into a front water tank and a rear water tank assembly, a water egress end connection tube of the front water tank is connected, in series, to the rear water tank assembly, and the front water tank is in abutting engagement with the temperature-receiving conducting plate, and a circulation tube is extended from a last one of rear water tanks of the rear water tank assembly to connect to the winding-tube return flow box, and the winding-tube return flow box is tube-connected to an opposite end of the last one of the rear water tanks to directly tube-connect back to the front water tank, and a volumetric horizontal average dimensional size of each of the tanks of the front water tank and the rear water tank assembly is smaller than a volumetric horizontal average dimensional size of a cold-generation ice water tank of a prior art vehicle air-conditioning structure of this type, and total water storage capacity of a sum of the front water tank and the rear water tank assembly is not less than a total water storage capacity of a single one-piece cold-generation ice water tank of the prior art vehicle air-conditioning structure of this type.

2. The vehicle air-conditioning device using semiconductor as a cooling core according to claim 1, wherein a temperature-reducing conducting bar having a bar body from which multiple closely arranged conduction plates project is suspended down and protrudes from an inner tank side of the front water tank on which the temperature-receiving conducting plate is stacked to extend into in-tank water of the cold-generation ice water tank.

3. The vehicle air-conditioning device using semiconductor as a cooling core according to claim 1, wherein the rear water tank assembly comprises one single rear water tank.

4. The vehicle air-conditioning device using semiconductor as a cooling core according to claim 1, wherein the rear water tank assembly comprises plural rear water tanks connected in cascade with tubing.

5. The vehicle air-conditioning device using semiconductor as a cooling core according to claim 1, wherein the fans arranged around the temperature-reducing conducting fins of the winding-tube return flow box are drum fans.

6. The vehicle air-conditioning device using semiconductor as a cooling core according to claim 1, wherein the fans arranged around the temperature-reducing conducting fins of the winding-tube return flow box are roller fans.

7. The vehicle air-conditioning device using semiconductor as a cooling core according to claim 1, wherein the power switch, the temperature rising/lowering control button, and the constant-temperature control button of the main control interface in the vehicle-equipped air conditioning controller are of a hardware structure having a physical form of a button.

8. The vehicle air-conditioning device using semiconductor as a cooling core according to claim 1, wherein the power switch, the temperature rising/lowering control button, and the constant-temperature control button of the main control interface in the vehicle-equipped air conditioning controller are in the form of digital image touch-control virtual key structure wire-connected with and operating in combination with the set of electricity supplying and temperature controlling circuit.

9. The vehicle air-conditioning device using semiconductor as a cooling core according to claim 1, wherein the heat-dissipating fan module comprises a combined body of an electronic fan stacked with grating row blocks penetrated and connected by heat-conducting tubes, and the cold-generation ice water tank, either the front water tank or the rear water tank assembly, having a top thereof stacked with the temperature-receiving conducting plate in tight abutting engagement with the cold generation surface of the thermoelectric cooling chip, and the heat generation surface of the electrical cooling chip is stacked with the heat-dissipating fan module, wherein the front water tank comprises an aluminum alloy cold water tank, and on a tank inner side stacked with the temperature-receiving conducting plate, an aluminum plate array suspends downward and protrudes from an inner tank top surface to dip into in-tank water, and the rear water tank assembly comprises an aluminum alloy water passage tank of which an interior is penetrated through to form a cold water circuitous passageway.

10. The vehicle air-conditioning device using semiconductor as a cooling core according to claim 1, wherein the heat-dissipating fan module comprises a single electronic fan unit.
